(19) United States
(12) Patent Application Publication
(10) Pub. No.: US 2023/0327580 A1
(43) Pub. Date: Oct. 12, 2023

(54) DRIVE CONTROL DEVICE AND ULTRASONIC MOTOR SYSTEM

(71) Applicant: Murata Manufacturing Co., Ltd., Nagaokakyo-shi (JP)

(72) Inventors: Mitsushiro TERASAWA, Nagaokakyo-shi (JP); Masaaki TAKATA, Nagaokakyo-shi (JP); Takahito KUSHIMA, Nagaokakyo-shi (JP); Yuzo MIZUSHIMA, Nagaokakyo-shi (JP); Katsuhisa HIGASHIYAMA, Nagaokakyo-shi (JP)

(21) Appl. No.: 18/336,194

(22) Filed: Jun. 16, 2023

Related U.S. Application Data
(63) Continuation of application No. PCT/JP2022/002229, filed on Jan. 21, 2022.

(30) Foreign Application Priority Data
Feb. 12, 2021 (JP) 2021-020718

(51) Int. Cl. H02N 2/14; H02N 2/16

(52) U.S. Cl. CPC H02N 2/142; H02N 2/166

(57) ABSTRACT

A drive control device is provided that drives an ultrasonic motor element including a vibrating body and piezoelectric elements provided on the vibrating body. The drive control device includes a speed detector that detects a driving speed of the ultrasonic motor element, a controller that sets drive conditions of the ultrasonic motor element, and a drive circuit unit that applies a drive voltage to the piezoelectric elements based on the drive conditions set by the controller. Moreover, the controller sets the drive conditions of the ultrasonic motor element based on the accumulated operation time for each driving speed of the ultrasonic motor element.

### CROSS REFERENCE TO RELATED APPLICATIONS

This application is a continuation of PCT Application No. PCT/JP2022/002229, filed Jan. 21, 2022, which claims priority to Japanese Patent Application No. 2021-020718, filed Feb. 12, 2021, the entire contents of each of which are hereby incorporated by reference in their entirety.

### TECHNICAL FIELD

The present invention relates to a drive control device that drives a driver having piezoelectric elements, and an ultrasonic motor system having piezoelectric elements.

### BACKGROUND

Conventionally, various ultrasonic motors vibrating a stator by piezoelectric elements have been proposed. For example, an ultrasonic motor has been provided that includes a stator including a plurality of polarized piezoelectric elements, and a rotor in contact with the stator. Signals having mutually different phases are applied to the plurality of polarized piezoelectric elements, so that the stator vibrates. The vibrations cause the rotor to rotate.

An optimum frequency of each signals applied to the piezoelectric elements varies depending on a contact pressure between the stator and the rotor, a temperature of the ultrasonic motor, and a load applied to the ultrasonic motor. Therefore, appropriate feedback control on the frequency of the above signals enables the ultrasonic motor to be efficiently driven.

In an example, Japanese Patent Application Laid-Open No. 2003-219668 (hereinafter “Patent Document 1”) discloses an ultrasonic motor control device in which a rotation speed of the ultrasonic motor is fed back from a speed detector to a controller. Moreover, a correction coefficient is calculated according to a difference between the rotation speed and a standard characteristic. Instruction signals related to driving are controlled based on the correction coefficient and the standard characteristic.

In general, rotational characteristics of the ultrasonic motor are affected by a frictional force of the stator and the rotor. Here, a portion where the stator and the rotor are in contact with each other is easily worn when the stator and the rotor rotate at a low speed. Therefore, it is important to manage operation time of rotation at a low speed. For example, in recent years, ultrasonic motors have been used for vehicles and the like. In such a case, it is particularly important to control the rotation of the ultrasonic motor at a low speed. Further, the life of the ultrasonic motor can be prolonged by an appropriate control.

On the other hand, in a conventional ultrasonic motor used in a printer, a camera, or the like, as described in Patent Document 1, the ultrasonic motor is less frequently used at a low speed where wear is severe. Therefore, the control of the rotation at a low speed is not important, and a problem of life prolongation hardly occurs.

### SUMMARY OF THE INVENTION

Accordingly, it is an object of the present invention to provide a drive control device that prolong the life of an ultrasonic motor element, and an ultrasonic motor system using the same.

In an exemplary aspect, a drive control device is provided that is configured to drive an ultrasonic motor element that includes a vibrating body and piezoelectric elements provided on the vibrating body. In this aspect, the drive control device includes a speed detector that configured to detect a driving speed of the ultrasonic motor element; a controller configured to set drive conditions of the ultrasonic motor element; and a drive circuit unit configured to apply a drive voltage to the piezoelectric elements based on the drive conditions set by the controller, in which the controller sets the drive conditions of the ultrasonic motor element based on accumulated operation time for each driving speed of the ultrasonic motor element.

Moreover, in an exemplary aspect, an ultrasonic motor system is provided that includes a drive control device as described above, and the ultrasonic motor element includes the vibrating body and the piezoelectric elements.

According to the drive control device and the ultrasonic motor system of the exemplary aspects of the present disclosure, the life of the ultrasonic motor element can be prolonged.

### BRIEF DESCRIPTION OF DRAWINGS

FIG. 1 is a connection relationship diagram of an ultrasonic motor element and a drive control circuit in a first exemplary embodiment.

FIG. 2 is a schematic control circuit diagram of an ultrasonic motor system according to the first exemplary embodiment.

FIG. 3 is a bottom view of a stator in the first exemplary embodiment.

FIG. 4 is a front sectional view of a first piezoelectric element in the first exemplary embodiment.

FIG. 5 is a flowchart illustrating an operation procedure of a drive control device in the first exemplary embodiment.

FIGS. 6(a) to 6(c) are schematic bottom views of the stator for easily describing a traveling wave.

FIG. 7 is a plan view of a piezoelectric element in a first modification of the first exemplary embodiment.

FIG. 8 is a schematic control circuit diagram of an ultrasonic motor system according to a second modification of the first exemplary embodiment.

FIG. 9 is a schematic control circuit diagram of an ultrasonic motor system according to a second exemplary embodiment.

FIG. 10 is a flowchart illustrating an operation procedure of a drive control device in the second exemplary embodiment.

FIG. 11 is a schematic control circuit diagram of an ultrasonic motor system according to a third exemplary embodiment.

FIG. 12 is a schematic control circuit diagram of an ultrasonic motor system according to a fourth exemplary embodiment.

FIG. 13 is a schematic control circuit diagram of an ultrasonic motor system according to a fifth exemplary embodiment.

FIG. 14 is a schematic side view of an ultrasonic motor element in a sixth exemplary embodiment.

### DETAILED DESCRIPTION

Hereinafter, the exemplary aspects of the present invention will be clarified by describing specific embodiments with reference to the drawings.

It is noted that each of the embodiments described in the present description is an exemplary embodiment, and replacement of some part or combination of configurations is possible among different embodiments.

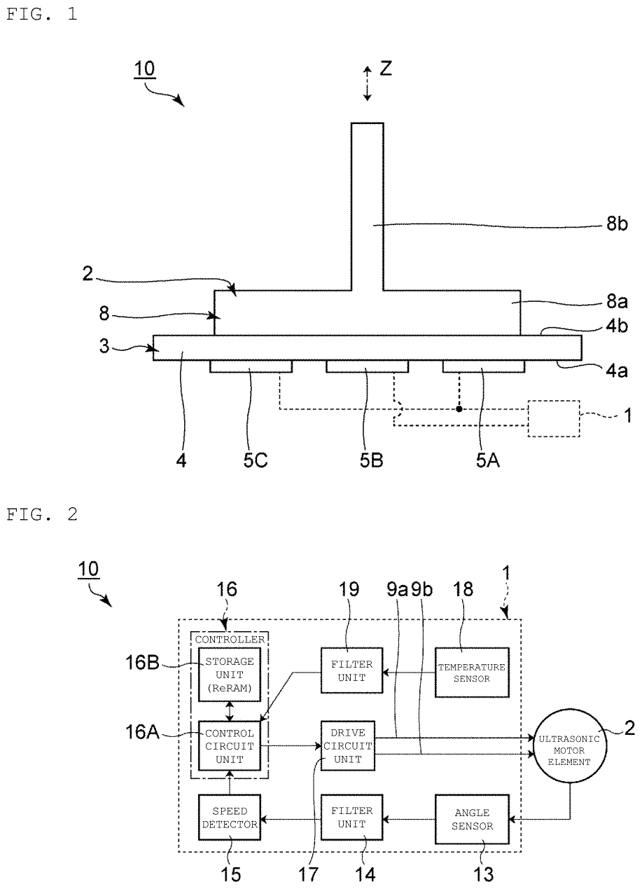

FIG. 1 is a connection relationship diagram of an ultrasonic motor element and a drive control circuit in a first exemplary embodiment.

As shown, an ultrasonic motor system 10 is provided that has a drive control device 1 and an ultrasonic motor element 2. The ultrasonic motor element 2 includes a stator 3 and a rotor 8. In the ultrasonic motor system 10, driving signals are applied from the drive control device 1 to the stator 3. The stator 3 is thereby vibrated, so that a traveling wave circling around an axial direction Z is generated. Here, the stator 3 and the rotor 8 are in contact with each other. The traveling wave generated at the stator 3 causes the rotor 8 to rotate. Hereinafter, a specific configuration of the ultrasonic motor system 10 will be described.

As illustrated in FIG. 1, the stator 3 has a vibrating body 4 that has a disk shape. The vibrating body 4 has a first main surface 4a and a second main surface 4b that faces the first main surface 4a. In the present description, the axial direction Z is a direction along which the first main surface 4a and the second main surface 4b are linked, and is a direction along a rotation center. Note that, a shape of the vibrating body 4 is not limited to a disk shape. For example, in alternative aspects, the shape of the vibrating body 4 viewed from the axial direction Z may be a regular polygon such as a regular hexagon, a regular octagon, or a regular decagon. The vibrating body 4 is made of an appropriate metal. However, the vibrating body 4 is not necessarily made of metal. For example, the vibrating body 4 can be configured with another elastic body such as ceramics, a silicon material, or a synthetic resin according to alternative aspects.

Here, the piezoelectric elements shown in the following embodiments are polarized into more than one. An example of the plurality of polarized piezoelectric elements includes one piezoelectric element having different polarization directions for different regions. Alternatively, one example of the piezoelectric elements polarized into more than one includes a plurality of piezoelectric elements having mutually different polarization directions.

At the first main surface 4a of the vibrating body 4, the piezoelectric elements polarized into more than one are provided. More specifically, the plurality of piezoelectric elements having mutually different polarization directions are provided. The second main surface 4b is in contact with the rotor 8. The rotor 8 has a rotor body 8a and a rotating shaft 8b. The rotor body 8a has a disk shape. One end of the rotating shaft 8b is coupled to the rotor body 8a. The rotor body 8a is in contact with the second main surface 4b of the vibrating body 4. It is noted that a shape of the rotor body 8a is not limited to a disk shape. For example, the shape of the rotor body 8a viewed from the axial direction Z may be a regular polygon such as a regular hexagon, a regular octagon, or a regular decagon.

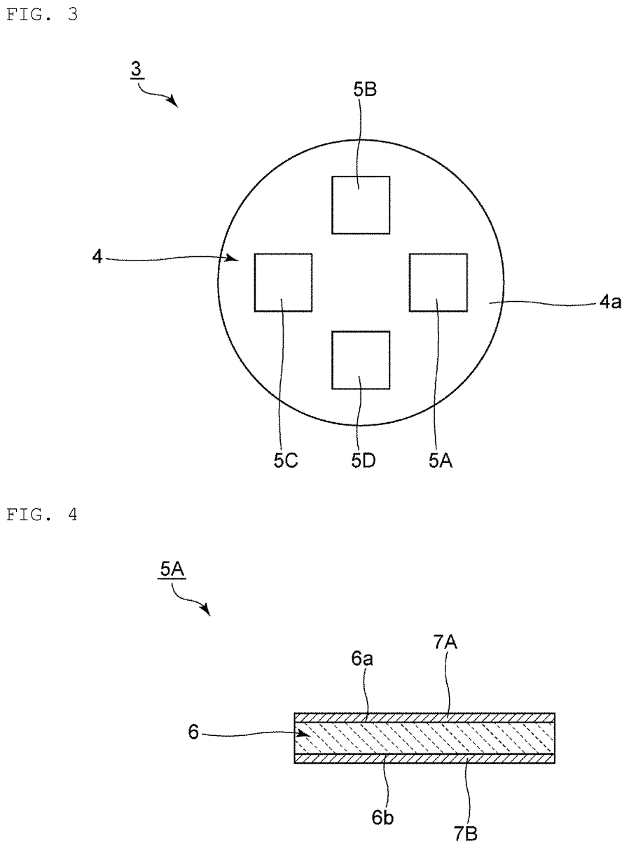

FIG. 2 is a schematic control circuit diagram of an ultrasonic motor system according to the first exemplary embodiment.

The drive control device 1 includes an angle sensor 13, a filter unit 14, a speed detector 15, a controller 16, a drive circuit unit 17, a temperature sensor 18, and a filter unit 19. The angle sensor 13 is connected to the speed detector 15 with the filter unit 14 interposed therebetween. The speed detector 15 is connected to the controller 16. The temperature sensor 18 is connected to the controller 16 with the filter unit 19 interposed therebetween. The controller 16 is connected to the drive circuit unit 17. Furthermore, the drive circuit unit 17 and the angle sensor 13 are connected to the ultrasonic motor element 2.

The angle sensor 13 is configured to detect a rotation angle of the ultrasonic motor element 2 and to further output signals corresponding to the rotation angle to the speed detector 15. The filter unit 14 is configured to filter signals output from the angle sensor 13 to the speed detector 15. The speed detector 15 is configured to detect a driving speed of the ultrasonic motor element 2. More specifically, in the present embodiment, the driving speed is rotation speed, which can be, for example, rpm.

The temperature sensor 18 is configured to detect the temperature of the ultrasonic motor element 2 and outputs signals corresponding to the temperature to the controller 16. The filter unit 19 is configured to filter signals output from the temperature sensor 18 to the controller 16. Note that, a temperature calculation unit may be connected between the filter unit 19 and the controller 16. In this case, the temperature calculation unit calculates the temperature based on the signals output from the temperature sensor 18. Moreover, the temperature calculation unit is configured to output signals corresponding to the calculated temperature to the controller 16. However, in the present embodiment, the controller 16 can read temperature data from the temperature sensor 18.

In the exemplary aspect, the controller 16 is configured to set drive conditions of the ultrasonic motor element 2. More specifically, the controller 16 includes a control circuit unit 16A and a storage unit 16B. In the control circuit unit 16A, the drive conditions are set. In the present embodiment, the storage unit 16B is a resistance change memory (ReRAM). However, the storage unit 16B is not limited to the ReRAM. Moreover, in an exemplary aspect, the control circuit unit 16A can be a computer processor (e.g., CPU) or the like configured to execute instructions on the storage unit 16B to perform the algorithms and functions described herein.

The drive circuit unit 17 is configured to apply a drive voltage to each piezoelectric element of the ultrasonic motor element 2 based on the drive conditions set by the controller 16.

A feature of the present embodiment is that the controller 16 is configured to set the drive conditions of the ultrasonic motor element 2 based on the accumulated operation time for each driving speed of the ultrasonic motor element 2. Accordingly, the rotation of the ultrasonic motor element 2 at a low speed can be controlled more accurately, and the life of the ultrasonic motor system 10 can be extended. The details thereof will be described below together with details of the configuration of the present embodiment.

FIG. 3 is a bottom view of the stator in the first embodiment.

In the present embodiment, the piezoelectric elements polarized into more than one are a first piezoelectric element 5A, a second piezoelectric element 5B, a third piezoelectric element 5C, and a fourth piezoelectric element 5D. The plurality of piezoelectric elements are attached to the vibrating body 4 with an adhesive. An example of the adhesive that can be used is an epoxy resin, a polyethylene resin, or the like.

To generate the traveling wave circling around the axis parallel to the axial direction Z, the piezoelectric elements polarized into more than one are distributed along a circling direction of the traveling wave. When viewed from the axial direction Z, the first piezoelectric element 5A and the third piezoelectric element 5C face each other with the axis interposed therebetween. Moreover, the second piezoelectric element 5B and the fourth piezoelectric element 5D face each other with the axis interposed therebetween.

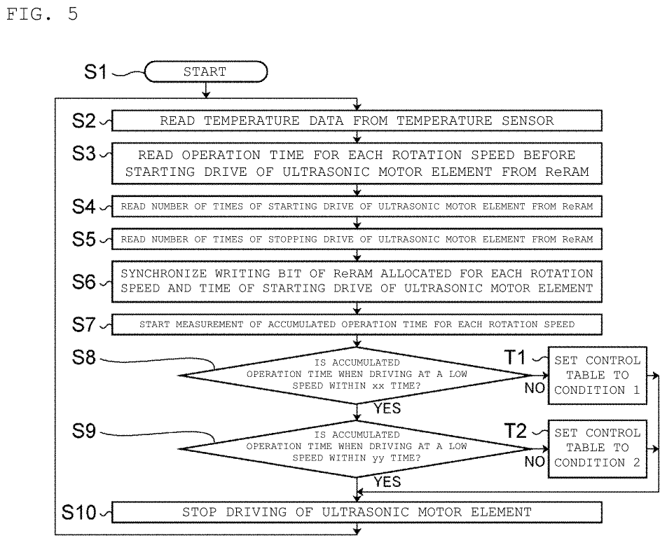

FIG. 4 is a front sectional view of the first piezoelectric element in the first embodiment.

The first piezoelectric element 5A has a piezoelectric body 6 that has third main surfaces 6a and fourth main surfaces 6b that face each other. The first piezoelectric element 5A has a first electrode 7A and a second electrode 7B. The piezoelectric body 6 is polarized from the third main surface 6a toward the fourth main surface 6b. The first electrode 7A is provided at the third main surface 6a of the piezoelectric body 6 and the second electrode 7B is provided at the fourth main surface 6b of the piezoelectric body 6.

The second piezoelectric element 5B, the third piezoelectric element 5C, and the fourth piezoelectric element 5D are configured similarly to the first piezoelectric element 5A. However, the piezoelectric body 6 in the first piezoelectric element 5A and the piezoelectric body 6 in the third piezoelectric element 5C are polarized in mutually opposite directions. Similarly, the piezoelectric body 6 in the second piezoelectric element 5B and the piezoelectric body 6 in the fourth piezoelectric element 5D are also polarized in mutually opposite directions. In other words, the first, second, third, and fourth piezoelectric elements 5A, 5B, 5C, and 5D, are the piezoelectric elements polarized into more than one.

The first piezoelectric element 5A and the third piezoelectric element 5C are connected to the drive circuit unit 17 by a first wiring 9a illustrated in FIG. 2. Therefore, the same signals are applied to the first piezoelectric element 5A and the third piezoelectric element 5C. Further, since the piezoelectric bodies 6 of the first piezoelectric element 5A and the third piezoelectric element 5C are polarized in mutually opposite directions, the first piezoelectric element 5A and the third piezoelectric element 5C vibrate in phases opposite to each other. On the other hand, the second piezoelectric element 5B and the fourth piezoelectric element 5D are connected to the drive circuit unit 17 by a second wiring 9b. Therefore, the same signals are applied to the second piezoelectric element 5B and the fourth piezoelectric element 5D. Further, since the piezoelectric bodies 6 of the second piezoelectric element 5B and the fourth piezoelectric element 5D are polarized in mutually opposite directions, the second piezoelectric element 5B and the fourth piezoelectric element 5D vibrate in phases opposite to each other.

For purposes of this disclosure, one of the mutually different phases is denoted as an A phase, and the other is denoted as a B phase. A phase difference between the A phase and the B phase in the present embodiment is 90°. In the present embodiment, A-phase signals are applied to the first piezoelectric element 5A and the third piezoelectric element 5C. B-phase signals are applied to the second piezoelectric element 5B and the fourth piezoelectric element 5D. It is noted that the technology of the exemplary aspects can also be applicable to, for example, a case where the control is performed in three phases. The drive control device 1 vibrates the stator 3 based on a flow illustrated in FIG. 5 to rotationally drive the ultrasonic motor element 2.

FIG. 5 is a flowchart illustrating an operation procedure of the drive control device in the first embodiment.

As illustrated in FIG. 5, the operation is started in step S1. In step S2, the temperature data is read from the temperature sensor 18. Note that, when the temperature calculation unit is connected between the temperature sensor 18 and the controller 16, the controller 16 reads temperature data from the temperature calculation unit.

In step S3, the operation time for each rotation speed before starting a rotation drive of the ultrasonic motor element 2 is read from the ReRAM. More specifically, the operation time for each rotation speed is the accumulated operation time for each rotation speed before starting the rotation drive of a current cycle. For purposes of this disclosure, it is noted that “every rotation speed” means “every rotation speed range” set in the controller 16.

In step S4, a reading from the ReRAM is performed for the number of times the rotation drive of the ultrasonic motor element 2 is started. In step S5, the number of times the rotation drive of the ultrasonic motor element 2 is stopped is read from the ReRAM.

In step S6, a write bit of the ReRAM allocated for each rotation speed is synchronized with time at which the driving of the ultrasonic motor element 2 is started. Next, step S7 is performed simultaneously with the start of driving of the ultrasonic motor element 2. In step S7, a measurement of the accumulated operation time for each rotation speed is started.

In step S8, it is determined whether or not the accumulated operation time at the time of driving at a low speed is within xx hours. Note that, “xx” is an arbitrary numerical value. The numerical value of “xx” may be set according to applications or the like. When the accumulated operation time at the time of driving at a low speed is within xx hours, the procedure proceeds to step S9. On the other hand, when the accumulated operation time exceeds xx hours, the procedure proceeds to step T1. Note that, the rotation speed at the time of driving at a low speed is preferably set to, for example, 1 rpm or less.

In step T1, a control table is set to condition 1. Specifically, this control table is related to the drive conditions of the ultrasonic motor element 2. In the control table, for example, as shown in Table 1, a sweep start frequency and a sweep stop frequency corresponding to the accumulated operation time are set. Here, the sweep start frequency and the sweep stop frequency define a range of a frequency sweep performed to identify an optimum frequency of signals applied to each piezoelectric element of the ultrasonic motor element 2. Note that, Table 1 shows an example of a case where the conditions are set only according to the accumulated operation time.

TABLE 1

| | Accumulated | Sweep start | Sweep stop |
|---|---|---|---|
| | operation time | frequency | frequency |
| Condition 1 | Within xx time | . . . | . . . |
| Condition 2 | Within yy time | . . . | . . . |

Further, as in the example shown in Table 2, the one or more drive conditions may be set according to the temperature measured by the temperature sensor 18. In addition, the drive voltage and the phase difference between the A phase and the B phase may be set in the control table.

TABLE 2

| | Accumulated | | Sweep start | Sweep stop |
|---|---|---|---|---|
| | operation time | Temperature | frequency | frequency |
| Condition 1 | Within xx | a | . . . | . . . |
| | time | | | |
| Condition 1 | Within xx | b | . . . | . . . |
| | time | | | |
| Condition 1 | Within xx | c | . . . | . . . |
| | time | | | |
| Condition 2 | Within yy | a | . . . | . . . |
| | time | | | |
| Condition 2 | Within yy | b | . . . | . . . |
| | time | | | |
| Condition 2 | Within yy | c | . . . | . . . |
| | time | | | |

When the procedure proceeds to step T1, the drive circuit unit 17 applies a drive voltage to each piezoelectric element based on the condition 1. After step T1 is performed, the procedure proceeds to step S10. On the other hand, in step S9, it is determined whether or not the accumulated operation time at the time of driving at a low speed is within yy time. Note that, “yy” is an arbitrary numerical value. A numerical value of “yy” may be set according to the applications or the like. In a case where the accumulated operation time at the time of driving at a low speed is within yy time, the procedure proceeds to step S10. On the other hand, in a case where the accumulated operation time exceeds yy time, the procedure proceeds to step T2.

In step T2, the control table is set to condition 2. In a case where the procedure proceeds to step T2, the drive circuit unit 17 applies a drive voltage to each piezoelectric element based on the condition 2. After step T2 is performed, the procedure proceeds to step S10.

In step S10, the driving of the ultrasonic motor element 2 is stopped. More specifically, driving of each piezoelectric element is stopped by stopping power supply to the ultrasonic motor element 2. As a result, the driving of the ultrasonic motor element 2 is stopped by stopping the vibration of the vibrating body 4. After step S10 is performed, the procedure returns to step S2. The drive control device 1 repeats the operation as described above. Note that, extra conditions for returning from step T1 or step T2 to step S10 may be provided according to the applications of the ultrasonic motor element 2. Examples of the above conditions can include a case where the ultrasonic motor element 2 is rotated for a certain period of time and a case where an abnormality is detected.

In the example illustrated in FIG. 5, there are two conditions to be set in the control table. However, three or more conditions may be set in the control table. In this case, in addition to step S8, step S9, step T1, and step T2, a step of determining a range of the accumulated operation time during the driving at a low speed and a step of setting the conditions in the control table may be separately provided. At least one of the determination step and the condition setting step may be provided between step S9 and step S10. Note that, the conditions set in the control table may be, for example, 10 or less. In this case, the operation procedures are not too complicated, and the driving of the ultrasonic motor element 2 can be sufficiently accurately controlled.

As described above, a portion where the stator 3 and the rotor 8 illustrated in FIG. 1 are in contact with each other is particularly likely to wear in a case where the stator 3 and the rotor 8 rotate at a low speed. Here, in the present embodiment, the control circuit unit 16A sets the drive conditions of the ultrasonic motor element 2 based on the accumulated operation time for each rotation speed of the ultrasonic motor element 2. More specifically, the drive conditions are set based on the accumulated operation time for each rotation speed set to the low speed among the accumulated operation time for each rotation speed stored in the storage unit 16B. As a result, the rotation of the ultrasonic motor element 2 can be more accurately controlled at a low speed. Therefore, it is possible to more reliably perform more appropriate control on the state of wear of the portion where the stator 3 and the rotor 8 are in contact with each other. Moreover, the life of the ultrasonic motor element 2 can be prolonged.

Note that, after the step of determining the accumulated operation time for each rotation speed such as step S8, a step of determining other than the accumulated operation time may be provided. More specifically, the drive conditions of the ultrasonic motor element 2 may be set based on the accumulated operation time for each rotation speed of the ultrasonic motor element 2 and other conditions.

In an exemplary aspect, the drive conditions of the ultrasonic motor element 2 is preferably set based on the accumulated operation time and the number of times of starting the driving of the ultrasonic motor element 2. The portion where the stator 3 and the rotor 8 are in contact with each other is particularly easily worn at the start of driving. Therefore, by setting the drive conditions according to the number of times of starting the driving in addition to the accumulated operation time, more appropriate control can be performed.

In this case, for example, a step of determining which range the number of times read in step S4 falls within may be provided. After the step is performed, the procedure may proceed to a step of setting conditions in the control table according to which range the number of times is. At this time, the conditions may be selected by providing a plurality of determination steps as in steps S8 and S9.

The accumulated operation time of the ultrasonic motor element 2 preferably includes a time during which the ultrasonic motor element 2 is driven when the supply of the power to the ultrasonic motor element 2 is stopped. The drive conditions of the ultrasonic motor element 2 are preferably set based on the accumulated operation time. After the power supply to the ultrasonic motor element 2 is stopped in step S10, the ultrasonic motor element 2 does not actually stop immediately. After the power supply is stopped, self-excited vibration is generated in the vibrating body 4, so that the ultrasonic motor element 2 is rotationally driven. Also in this case, the portion where the stator 3 and the rotor 8 are in contact with each other wears. Therefore, by setting the drive conditions as described above, it is possible to more reliably perform more appropriate control for the wear of the portion where the stator 3 and the rotor 8 are in contact with each other.

In an exemplary aspect, the drive conditions of the ultrasonic motor element 2 are preferably set based on the accumulated operation time and the temperature of the ultrasonic motor element 2 detected by the temperature sensor 18. Accordingly, a more appropriate control can be performed.

In this case, for example, after step S8, a step of determining which temperature range the temperature data read in step S2 falls within may be provided. After execution of this step, the procedure may proceed to a step of setting the conditions in the control table according to which temperature range the temperature data is in. At this time, the conditions may be selected by providing a plurality of determination steps as in steps S8 and S9.

Note that, step S2, step S4, and step S5 are not necessarily included in the operation procedures. Steps may be provided according to a target to be determined when setting the drive conditions. The drive conditions of the ultrasonic motor element 2 may be set based on at least the accumulated operation time for each rotation speed of the ultrasonic motor element 2. When the temperature of the ultrasonic motor element 2 is not included in the target for setting the drive conditions, the drive control device 1 may not include the temperature sensor 18 and the filter unit 19.

The generation of the traveling wave will be described below. Note that, in the stator 3, a structure in which a plurality of piezoelectric elements is dispersedly disposed in a circumferential direction and driven to generate the traveling wave is disclosed, for example, in WO 2010/061508 A1, the contents of which are hereby incorporated by reference.

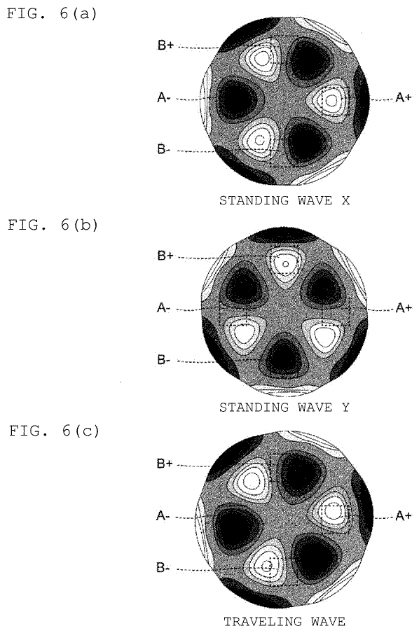

FIGS. 6(a) to 6(c) are schematic bottom views of the stator for easily describing the traveling wave. Note that, FIGS. 6(a) to 6(c) show that, in a gray scale, the closer to black, the stronger the stress in one direction, and the closer to white, the stronger the stress in the other direction.

FIG. 6(a) shows three standing waves X, and FIG. 6(b) shows three standing waves Y. It is assumed that the first piezoelectric element 5A, the second piezoelectric element 5B, the third piezoelectric element 5C, and the fourth piezoelectric element 5D are arranged at an angle of a central angle of 90°. In this case, since the three standing waves X and Y are excited, the central angle corresponding to the wavelength of the traveling wave is 120°. In other words, the first, second, third, and fourth piezoelectric elements 5A, 5B, 5C, and 5D have dimensions in the circumferential direction corresponding to 120°×3/4=90° in the central angle. Neighboring piezoelectric elements are separated at an interval corresponding to a central angle of 120°×3/4=90°. In this case, as described above, the three standing waves X and Y having phases different from each other by 90° are excited, and the standing waves X and Y are combined to generate the traveling wave illustrated in FIG. 6(c).

It is noted that in FIGS. 6(a) to 6(c), “A+”, “A−”, “B+”, and “B−” represent polarization directions of the piezoelectric body 6. “+” means that polarization is established from the third main surface 6a toward the fourth main surface 6b in a thickness direction. “−” means that polarization is established in an opposite direction. “A” denotes the first piezoelectric element 5A and the third piezoelectric element 5C, and “B” denotes the second piezoelectric element 5B and the fourth piezoelectric element 5D.

As described above, the traveling wave traveling at the vibrating body 4 in its circumferential direction is generated, so that the rotor 8 in contact with the second main surface 4b of the vibrating body 4 rotates about a center in the axial direction Z. Note that, in the present invention, the configuration that generates the traveling wave is not limited to the configuration in the present embodiment, and conventionally known various configurations that generate the traveling wave can be used.

Moreover, the rotor body 8a can have a friction material fixed on its surface on the stator 3 side. Accordingly, the frictional force applied between the vibrating body 4 of the stator 3 and the rotor 8 can thereby be increased.

In the present embodiment, the center of the traveling wave coincides with the center of the stator 3 and the center of the vibrating body 4. However, the center of the traveling wave may not necessarily coincide with the center of the stator 3 or the center of the vibrating body 4.

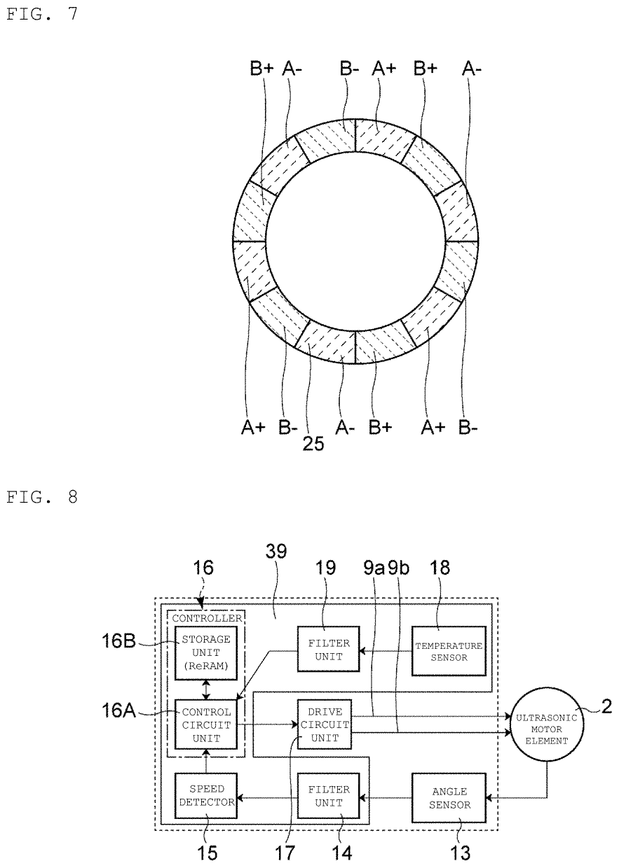

As described above, a plurality of piezoelectric elements are polarized into more than one. However, the plurality of polarized piezoelectric elements may be one piezoelectric element. In the first modification of the first embodiment illustrated in FIG. 7, a piezoelectric element 25 is one piezoelectric element polarized into more than one. The piezoelectric element 25 has an annular shape. The piezoelectric element 25 has a plurality of regions. The piezoelectric element 25 has different polarization directions for different regions. As a result, the piezoelectric element 25 thereby vibrates in mutually different phases in mutually different regions. The plurality of regions are arranged in the circumferential direction of the piezoelectric element 25. More specifically, the plurality of regions include a plurality of first A-phase regions, a plurality of second A-phase regions, a plurality of first B-phase regions, and a plurality of second B-phase regions. The piezoelectric element 25 includes three of each region described above. Note that, the piezoelectric element 25 is required to include at least one of each region described above.

The piezoelectric element 25 has a plurality of first electrodes. Each first electrode has an arc shape. The first electrodes provided in adjacent regions of the piezoelectric element 25 are not in contact with each other. The piezoelectric bodies of the piezoelectric element 25 of the present modification are polarized in mutually opposite directions in the first A-phase regions and the second A-phase regions. Similarly, the piezoelectric bodies of the piezoelectric element 25 are polarized in mutually opposite directions in the first B-phase regions and the second B-phase regions. In other words, the piezoelectric element 25 is the piezoelectric element polarized into more than one.

Also in the present modification, the operation procedures of the drive control device is similar to the flow illustrated in FIG. 5. Therefore, as in the first embodiment, the life of the ultrasonic motor element can be prolonged.

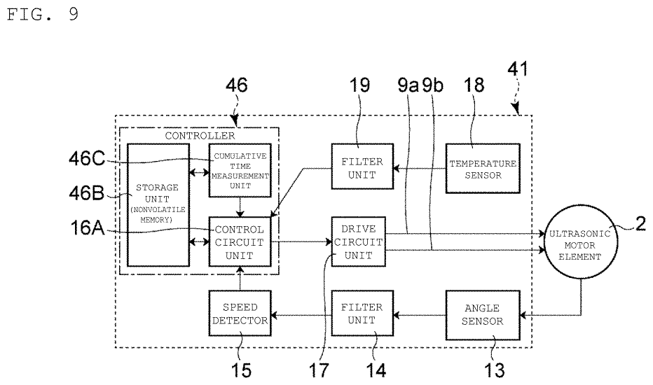

In the above description, the filter unit 14, the speed detector 15, the controller 16, the drive circuit unit 17, the temperature sensor 18, and the filter unit 19 are conceptually divided to describe the respective functions. However, the above elements do not need to be physically separated from each other in an exemplary aspect. For example, in the second modification of the first embodiment illustrated in FIG. 8, the filter unit 14, the speed detector 15, the controller 16, the drive circuit unit 17, the temperature sensor 18, and the filter unit 19 are included in a same microcomputer 39. Since the microcomputer 39 is configured, the number of components can be reduced. Moreover, it is noted that the filter unit 14 and the filter unit 19 are not limited to those configured by filter circuit components, and may be configured as a digital filter in the microcomputer 39. In this case, noise reduction can be intended. Note that, at least two of the filter unit 14, the speed detector 15, the controller 16, the drive circuit unit 17, the temperature sensor 18, and the filter unit 19 may be included in the same microcomputer 39.

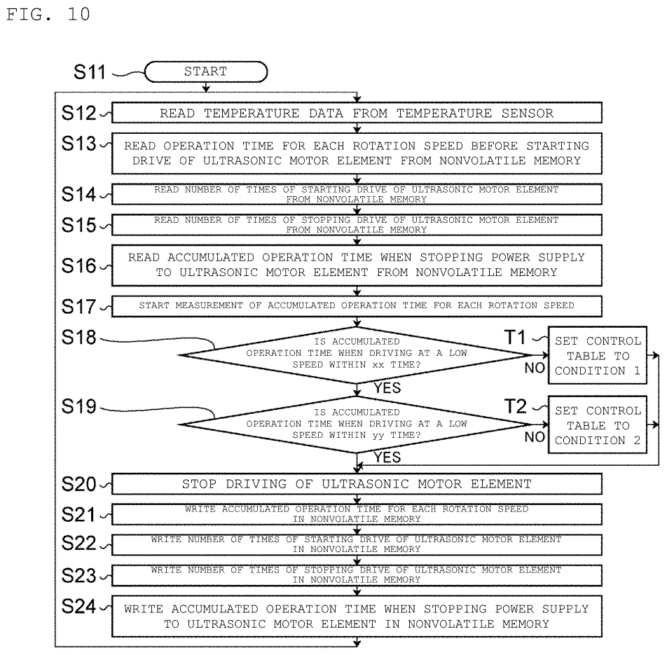

FIG. 9 is a schematic control circuit diagram of an ultrasonic motor system according to the second embodiment.

The present embodiment is different from the first embodiment in the configuration of the controller 46. Except for the above, the ultrasonic motor system of the present embodiment has the configuration similar to that of the ultrasonic motor system of the first embodiment.

A storage unit 46B of the controller 46 is a nonvolatile memory. The controller 46 further includes a cumulative time measurement unit 46C. The drive control device 41 vibrates the stator 3 by the flow illustrated in FIG. 10 to rotationally drive the ultrasonic motor element 2.

Steps S11 to S15 are similar to steps S1 to S5 illustrated in FIG. 5 except that the storage unit 46B is a nonvolatile memory. In step S16, the accumulated operation time when the power supply to the ultrasonic motor element 2 is stopped is read from the nonvolatile memory.

In step S17, the cumulative time measurement unit 46C starts measurement of the accumulated operation time for each rotation speed. Note that, at the same time as step S17, the driving of the ultrasonic motor element 2 is started. Steps S18 to S20, step T1, and step T2 are similar to steps S8 to S10, step T1, and step T2 illustrated in FIG. 5.

In step S21, the accumulated operation time for each rotation speed is written in the nonvolatile memory. In step S22, the number of times of starting the driving of the ultrasonic motor element 2 is written in the nonvolatile memory. In step S23, the number of times of stopping the driving of the ultrasonic motor element 2 is written in the nonvolatile memory. In step S24, the accumulated operation time when the power supply to the ultrasonic motor element 2 is stopped is written in the nonvolatile memory. After step S24 is performed, the procedure returns to step S12.

Also in the present embodiment, similarly to the first embodiment, the rotation of the ultrasonic motor element 2 can more accurately be controlled at a low speed. Therefore, it is possible to more reliably perform more appropriate control on the state of wear of the portion where the stator 3 and the rotor 8 are in contact with each other. Moreover, the life of the ultrasonic motor element 2 can be prolonged.

Note that, the storage unit 46B is a nonvolatile memory. Therefore, as illustrated in FIG. 10, a step of writing to the nonvolatile memory is provided as a step different from the reading from the nonvolatile memory. On the other hand, in the first embodiment, the storage unit 16B is a ReRAM. In this case, writing and reading can be performed simultaneously. Therefore, it is not necessary to separately provide the writing and reading steps. Furthermore, the accumulated operation time for each rotation speed can be measured and stored by the ReRAM. Therefore, as illustrated in FIG. 2, the controller 16 of the first embodiment does not include the cumulative time measurement unit 46C. For these reasons, the storage unit 16B is preferably a ReRAM. Accordingly, the operation procedures can be simplified, and the number of components can be reduced.

When the nonvolatile memory is used as in the second embodiment, at least two of the filter unit 14, the speed detector 15, the controller 46, the drive circuit unit 17, the temperature sensor 18, and the filter unit 19 may be included in the same microcomputer. In this case, the number of components can be reduced.

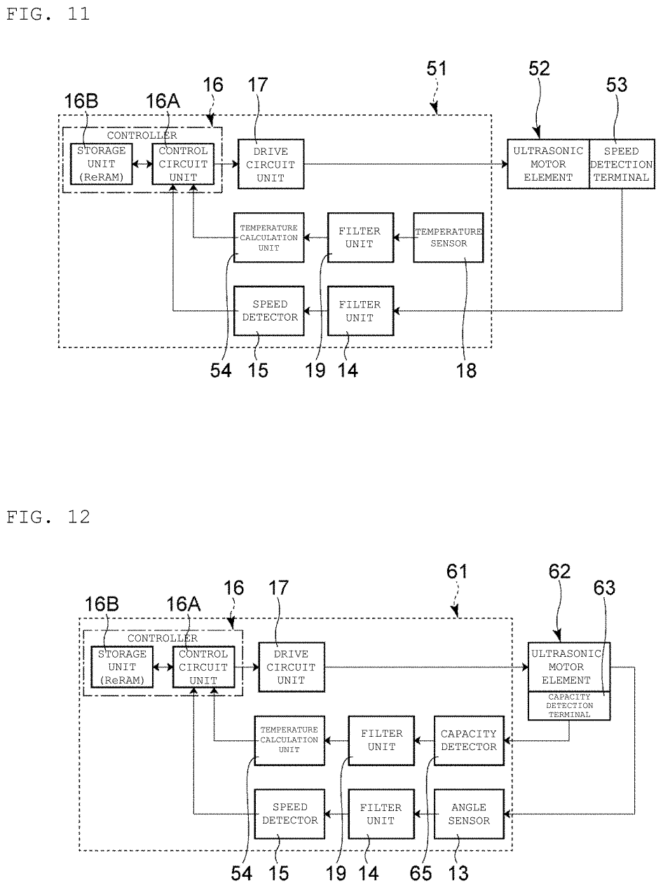

FIG. 11 is a schematic control circuit diagram of an ultrasonic motor system according to the third embodiment.

The present embodiment is different from the first embodiment in that an ultrasonic motor element 52 includes a speed detection terminal 53 and the drive control device 51 does not include the angle sensor 13. Furthermore, the present embodiment is different from the first embodiment in that the drive control device 51 includes a temperature calculation unit 54 that is connected between the filter unit 19 and the controller 16. Except for the above, the ultrasonic motor system of the present embodiment has the configuration similar to that of the ultrasonic motor system of the first embodiment.

The speed detection terminal 53 is provided on piezoelectric bodies 6 of first piezoelectric element 5A illustrated in FIG. 4. The speed detection terminal 53 outputs signals corresponding to the driving speed of the ultrasonic motor element 52 to the speed detector 15. As a result, the speed detector 15 detects the rotation speed of the ultrasonic motor element 52.

Also in the present embodiment, the operation procedure of the drive control device 51 is similar to the flow illustrated in FIG. 5. Therefore, as in the first embodiment, the life of the ultrasonic motor element 52 can be prolonged. In addition, since the drive control device 51 does not require an angle sensor, the number of components of the drive control device 51 can be reduced.

Note that, the controller 46 of the second embodiment may be used for the drive control device 51. In this case, the operation procedures of the drive control device 51 are similar to the flow illustrated in FIG. 10. Therefore, the life of the ultrasonic motor element 52 can be prolonged.

FIG. 12 is a schematic control circuit diagram of an ultrasonic motor system according to the fourth embodiment.

The present embodiment is different from the first embodiment in that an ultrasonic motor element 62 includes a capacity detection terminal 63. Furthermore, the present embodiment is different from the first embodiment in that the drive control device 61 includes a capacity detector 65 and the temperature calculation unit 54 and does not include the temperature sensor 18. Except for the above, the ultrasonic motor system of the present embodiment has the configuration similar to that of the ultrasonic motor system of the first embodiment.

According to an exemplary aspect, the capacity detection terminal 63 is provided on the piezoelectric bodies 6 of the first piezoelectric element 5A illustrated in FIG. 4. The capacity detection terminal 63 is not electrically connected to the first electrode 7A and the second electrode 7B of the first piezoelectric element 5A. Furthermore, the capacity detection terminal 63 is connected to the capacity detector 65 of the drive control device 61 illustrated in FIG. 12. The capacity detection terminal 63 outputs signals corresponding to the capacity of each piezoelectric element in the ultrasonic motor element 62 to the drive control device 61.

The capacity detector 65 is configured to detect the capacity of the first piezoelectric element 5A based on the signals output from the capacity detection terminal 63. The capacity detector 65 outputs the signals corresponding to the capacity to the temperature calculation unit 54. In the present embodiment, the capacity detector 65 is connected to the temperature calculation unit 54 via the filter unit 19. In this case, the filter unit 19 filters the signals output from the capacity detector 65 to the controller 16.

Note that, when the ultrasonic motor element 62 includes a plurality of piezoelectric elements, a plurality of capacity detection terminals 63 may be provided. Each capacity detection terminal 63 may be provided on each piezoelectric body 6 of each piezoelectric element. In this case, the capacity detector 65 detects the capacity of each piezoelectric element based on signals output from each capacity detection terminal 63.

In the drive control device 61, the temperature calculation unit 54 receives signals from the capacity detector 65 and calculates the temperature of the ultrasonic motor element 62. It is also noted that the capacity of the first piezoelectric element 5A depends on the temperature of the ultrasonic motor element 62. Therefore, the signals output from the capacity detection terminal 63 and the capacity detector 65 are signals based on the temperature of the ultrasonic motor element 62.

Also in the present embodiment, the operation procedures of the drive control device 61 are similar to the flow illustrated in FIG. 5. Therefore, as in the first embodiment, the life of the ultrasonic motor element 62 can be prolonged.

Note that, the controller 46 of the second embodiment may be used for the drive control device 61. In this case, the operation procedures of the drive control device 61 are similar to the flow illustrated in FIG. 10. Therefore, the life of the ultrasonic motor element 62 can be prolonged.

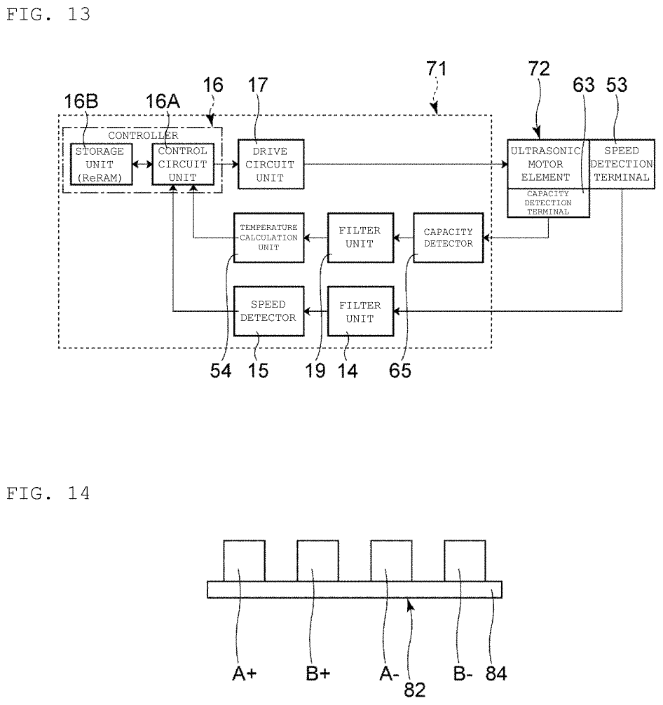

FIG. 13 is a schematic control circuit diagram of an ultrasonic motor system according to the fifth embodiment.

The present embodiment is different from the third embodiment in that an ultrasonic motor element 72 includes the capacity detection terminal 63. Furthermore, the present embodiment is different from the third embodiment in that a drive control device 71 includes the capacity detector 65 and does not include the temperature sensor 18. Except for the above, the ultrasonic motor system of the present embodiment has the configuration similar to that of the ultrasonic motor system 10 of the third embodiment.

The drive control device 71 detects the rotation speed similarly to the third embodiment, and detects the temperature of the ultrasonic motor element 72 similarly to the fourth embodiment. Also in the present embodiment, the operation procedures of the drive control device 71 are similar to the flow illustrated in FIG. 5. Therefore, as in the first embodiment, the third embodiment, and the fourth embodiment, the life of the ultrasonic motor element 72 can be prolonged. In addition, since the drive control device 71 does not require an angle sensor, the number of components of the drive control device 71 can be reduced.

It is also noted that the controller 46 of the second embodiment can be used for the drive control device 71. In this case, the operation procedures of the drive control device 71 are similar to the flow illustrated in FIG. 10. Therefore, the life of the ultrasonic motor element 72 can be prolonged.

As described above, in the first to fifth embodiments, the ultrasonic motor element is a rotationally driven element. However, the drive control device according to the present invention can also be used for an ultrasonic linear motor. An example thereof will be shown below.

FIG. 14 is a schematic side view of an ultrasonic motor element in the sixth embodiment.

The present embodiment is different from the first embodiment in that an ultrasonic motor element 82 is an ultrasonic linear motor. Except for the above, the ultrasonic motor system of the present embodiment has the configuration similar to that of the ultrasonic motor system of the first embodiment.

The vibrating body 84 of the ultrasonic motor element 82 has a rectangular parallelepiped shape. A first piezoelectric element, a second piezoelectric element, a third piezoelectric element, and a fourth piezoelectric element are provided on the vibrating body 84. The first piezoelectric element indicated by the symbol A+ and the third piezoelectric element indicated by the symbol A-vibrate in the A phase. The first piezoelectric element and the third piezoelectric element vibrate in phases opposite to each other. The second piezoelectric element indicated by the symbol B+ and the fourth piezoelectric element indicated by the symbol B-vibrate in the B phase. The second piezoelectric element and the fourth piezoelectric element vibrate in phases opposite to each other.

According to an exemplary aspect, the plurality of piezoelectric elements are arranged in a longitudinal direction of the vibrating body 84. More specifically, the first piezoelectric element, the second piezoelectric element, the third piezoelectric element, and the fourth piezoelectric element are arranged in this order. In the first to fifth embodiments, since the ultrasonic motor element is rotationally driven, the driving speed is the rotation speed. The driving speed in the present embodiment is a speed at which the ultrasonic motor element 82 itself moves. In this case, the unit of the driving speed is, for example, m/s.

In the present embodiment, the operation procedures of the drive control device are represented by a flow in which “rotation speed” is replaced with “driving speed” in the flow illustrated in FIG. 5. Therefore, as in the first embodiment, the life of the ultrasonic motor element 82 can be prolonged.

In general, it is noted that the exemplary embodiments described above are intended to facilitate the understanding of the present invention, and are not intended to limit the interpretation of the present invention. The exemplary aspects may be modified and/or improved without departing from the spirit and scope thereof, and equivalents thereof are also included in the present invention. That is, exemplary embodiments obtained by those skilled in the art applying design change as appropriate on the embodiments are also included in the scope of the present invention as long as the obtained embodiments have the features of the present invention. For example, each of the elements included in each of the embodiments, and arrangement, materials, conditions, shapes, sizes, and the like thereof are not limited to those exemplified above, and may be modified as appropriate. It is to be understood that the exemplary embodiments are merely illustrative, partial substitutions or combinations of the configurations described in the different embodiments are possible to be made, and configurations obtained by such substitutions or combinations are also included in the scope of the present invention as long as they have the features of the present invention.

### DESCRIPTION OF REFERENCE SYMBOLS

1: Drive control device
2: Ultrasonic motor element
3: Stator
4: Vibrating body
4a, 4b: First and second main surfaces
5A to 5D: First to fourth piezoelectric elements
6: Piezoelectric body
6a, 6b: Third and fourth main surfaces
7A, 7B: First and second electrodes
8: Rotor
8a: Rotor body
8b: Rotating shaft
9a, 9b: First and second wirings
10: Ultrasonic motor system
13: Angle sensor
14: Filter unit
15: Speed detector
16: Controller
16A: Control circuit unit
16B: Storage unit
17: Drive circuit unit
18: Temperature sensor
19: Filter unit
25: Piezoelectric element
39: Microcomputer
41: Drive control device
46: Controller
46B: Storage unit
46C: Cumulative time measurement unit
51: Drive control device
52: Ultrasonic motor element
53: Speed detection terminal
54: Temperature calculation unit
61: Drive control device
62: Ultrasonic motor element
63: Capacity detection terminal
65: Capacity detector
71: Drive control device
72: Ultrasonic motor element
82: Ultrasonic motor element
84: Vibrating body

1. A drive control device for driving an ultrasonic motor element that includes a vibrating body and piezoelectric elements disposed thereon, the drive control device comprising:
a speed detector configured to detect a driving speed of the ultrasonic motor element;
a controller configured to set at least one drive condition of the ultrasonic motor element based on an accumulated operation time for each driving speed of the ultrasonic motor element; and
a drive circuit unit configured to apply a drive voltage to the piezoelectric elements based on the at least one drive condition set by the controller.

2. The drive control device according to claim 1, wherein the ultrasonic motor element is a rotationally driven element, and the driving speed is a rotation speed.

3. The drive control device according to claim 1, wherein the controller is further configured to set the at least one drive condition based on the accumulated operation time for each driving speed of the ultrasonic motor element and a number of times of starting a driving of the ultrasonic motor element.

4. The drive control device according to claim 1, wherein the controller is configured to set the at least one drive condition based on the accumulated operation time for each driving speed of the ultrasonic motor element that includes a time when the ultrasonic motor element is driven while power supply to the ultrasonic motor element is stopped.

5. The drive control device according to claim 1, wherein the controller includes:
a control circuit unit configured to set the at least one drive condition of the ultrasonic motor element, and
a storage unit that stores at least the accumulated operation time for each driving speed of the ultrasonic motor element.

6. The drive control device according to claim 5, wherein the storage unit is a nonvolatile memory.

7. The drive control device according to claim 5, wherein the storage unit is a resistance change memory.

8. The drive control device according to claim 1, further comprising a temperature sensor configured to detect a temperature of the ultrasonic motor element and to further output a signal that corresponds to the temperature to the controller.

9. The drive control device according to claim 8, wherein the controller is further configured to set the at least one drive condition of the ultrasonic motor element based on the temperature detected by the temperature sensor.

10. The drive control device according to claim 1, wherein:
the ultrasonic motor element is a rotationally driven element,
the driving speed is a rotation speed,
the drive control device further comprises an angle sensor configured to detect a rotation angle of the ultrasonic motor element and to output a signal that corresponds to the rotation angle to the speed detector.

11. The drive control device according to claim 1, wherein the ultrasonic motor element is an ultrasonic linear motor.

12. The drive control device according to claim 1, wherein the piezoelectric elements of the ultrasonic motor element comprise two pairs of piezoelectric elements.

13. The drive control device according to claim 12, wherein each of the two pairs of piezoelectric elements are configured to vibrate in phases opposite to each other.

14. The drive control device according to claim 1, wherein the piezoelectric elements of the ultrasonic motor element are arranged in a longitudinal direction of the vibrating body.

15. An ultrasonic motor system comprising:
the drive control device according to claim 1; and
the ultrasonic motor element that includes the vibrating body and the piezoelectric elements.

16. The ultrasonic motor system according to claim 15, wherein:
the ultrasonic motor element includes a capacity detection terminal configured to output a signal that corresponds to a capacity of the piezoelectric elements, and
the drive control device includes:
a temperature calculation unit that receives a signal based on a temperature of the ultrasonic motor element and is configured to calculate a temperature of the ultrasonic motor element, and
a capacity detector configured to detect a capacity of the piezoelectric elements from the signal output by the capacity detection terminal and to output a signal that corresponds to the capacity to the temperature calculation unit.

17. The ultrasonic motor system according to claim 16, wherein the controller of the drive control device is further configured to set the at least one drive condition of the ultrasonic motor element based on the accumulated operation time for each driving speed of the ultrasonic motor element and the temperature calculated by the temperature calculation unit.

18. The ultrasonic motor system according to claim 15, further comprising:
a temperature sensor configured to detect a temperature of the ultrasonic motor element and to output a signal that corresponds to the temperature,
wherein the controller is configured to set the at least one drive condition of the ultrasonic motor element based on the accumulated operation time for each driving speed of the ultrasonic motor element and the temperature detected by the temperature sensor.

19. The ultrasonic motor system according to claim 15, wherein:
the ultrasonic motor element is a rotationally driven element,
the driving speed is a rotation speed, and
the drive control device includes an angle sensor configured to detect a rotation angle of the ultrasonic motor element and to output a signal that corresponds to the rotation angle to the speed detector.

20. The ultrasonic motor system according to claim 15, wherein the ultrasonic motor element includes a speed detection terminal configured to output a signal that corresponds to the driving speed of the ultrasonic motor element to the speed detector.
